(19) United States
(12) Patent Application Publication
(10) Pub. No.: US 2019/0279237 A1
(43) Pub. Date: Sep. 12, 2019

(54) Data Tracking

(71) Applicants: Terrrence Nevins, Lynnwood, WA (US); David Young, Bellevue, WA (US); Doug de la Torre, Bellevue, WA (US)

(72) Inventors: Terrrence Nevins, Lynnwood, WA (US); David Young, Bellevue, WA (US); Doug de la Torre, Bellevue, WA (US)

(21) Appl. No.: 16/297,628

(22) Filed: Mar. 9, 2019

Related U.S. Application Data
(60) Provisional application No. 62/640,915, filed on Mar. 9, 2018.

(51) Int. Cl. G06Q 30/02; G06F 16/2457; G06Q 50/00; H04L 9/32

(52) U.S. Cl. CPC G06Q 30/0203; G06F 16/24578; H04L 9/32; G06Q 50/01; G06Q 30/0217

(57) ABSTRACT

Data tracking is provided, which may provide ways for an entity to receive tailored feedback and recommendations based on data collected and analyzed from themed events that generate social engagement.

### FIELD

This disclosure relates generally to data tracking.

### BACKGROUND

Many entities promote brands or causes on websites, software applications, social media, or other host platforms. Entities have limited or no opportunity to access or capitalize on data that host platforms collect. Moreover, data collected fail to precisely address important issues that entities face.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, data tracking, which may provide improved techniques for providing tailored feedback and recommendations to entities based on data collected and analyzed from themed events that generate social engagement. Entities may include businesses, nonprofit organizations, groups, or individuals. Data tracking methods may integrate into practical applications of product development or market research, for example.

Many of the attendant features may be more readily appreciated as they become better understood by reference to the following detailed description considered in connection with the attached drawings.

### BRIEF DESCRIPTION OF THE DRAWINGS

FIG. 1 is a flow diagram for data tracking, according to one embodiment.

FIG. 2 illustrates a user interface layout for an application or website using a data tracking system, according to one embodiment.

FIG. 3 illustrates a user interface layout for an application or website using a data tracking system, according to one embodiment.

FIG. 4 is a block diagram with components that may be used in a data tracking system, according to one implementation.

FIG. 5 illustrates a system capable of supporting a data tracking system, according to one embodiment.

FIG. 6 is a component diagram of a computing device which may support a data tracking system, according to one embodiment.

### DETAILED DESCRIPTION

Many of the attendant features may be more readily appreciated as they become better understood by reference to the following detailed description considered in connection with the attached drawings, in which like parts are assigned like numerals.

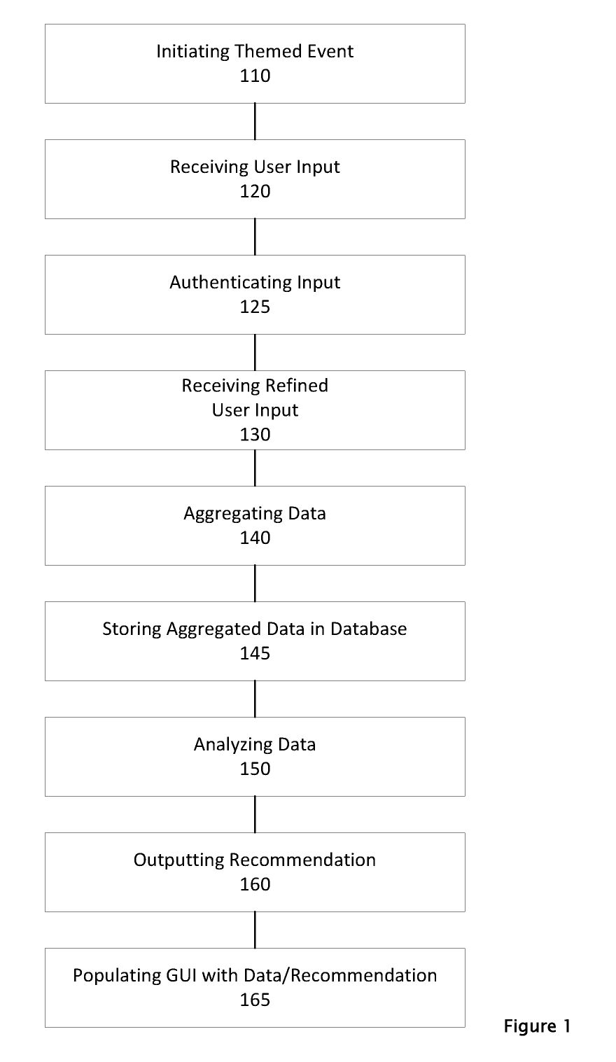

FIG. 1 is a flow diagram for a data tracking process, according to one embodiment. Various implementations of data tracking techniques may include computer-readable storage media containing sets of instructions to cause one or more processors to perform methods, variations of the methods, and other operations described herein.

At Initiate Themed Event 110, an entity may start a themed event that may attract social engagement. The entity may comprise a business, a nonprofit organization, a group, or an individual, for example. The event may comprise a photo or video contest, digital showcase, or any submission or sharing of content. The event may take place on an Internet site, software application, or another platform. The event may center on a theme that may relate to a product, service, business, organization, individual, place, activity, or another subject matter, even if it is unrelated to the entity.

For example, the themed event may comprise a photo contest inviting cat owners to submit recent photos of their cat eating a company's brand of cat food. In another example, it may comprise a video contest wherein cyclists submit video clips chronicling trips to a national park. In yet another example, the themed event may comprise a digital showcase inviting participants to share digital artwork, for example, a logo or musical composition created on a latest-model mobile device.

Content submission and sharing in the themed event may allow an entity to verify that participants are actual members of a target demographic for the entity's product or service, for example, people whose demographical or geographical data, buying habits, preferences, opinions, or other data may be relevant to the entity. For example, submission of a cat eating a brand of cat food may serve as photo evidence that the participant is an actual cat owner, consumer of the entity's brand, or a potential consumer of the entity's brand.

Entities may receive targeted answers from a reliable and focused group of qualified participants. This refinement of input may be advantageous over conventional focus groups or surveys, wherein it's difficult to obtain and retain a reliable pool of participants who aren't simply answering questions for a prize, with little or no proof of qualifications as a reliable source. The social engagement achieved by data tracking, via the themed event, may also allow entities to reach a larger pool of participants whose changes in opinions or behavior may be specifically tracked over time.

Data tracking methods may integrate into practical applications of product development and market research. For example, data collected from participants' submission or sharing of content may help an entity identify or resolve issues to improve marketing, product or service development, or may simply enhance an entity's database.

The themed events may attract social engagement by allowing users to receive rewards, in any form, for their participation. Participants may receive one or more instances of feedback in the form of scoring or ranking, for example. Users may receive monetary prizes or other tangible rewards. Users may also receive intangible rewards, for example, enhanced recognition, credibility, reputation, engagement, or exposure. The themed event may keep users engaged for short or long periods of time and may provide an entity with various opportunities for data tracking.

At Receiving User Input 120, data tracking may execute pauses in feedback wherein participants are prompted to provide input. For example, questions or other user prompts may appear before a participant could view the winner, receive their own score or ranking, or other feedback or reward. For example, cat owners may be prompted to answer whether they prefer to scoop or pour cat food, whether they prefer cat food to be placed on a higher or lower store shelf, or whether they prefer organic or conventional cat food, for example. Participants may also be prompted to questions unrelated to an entity's product or services, for example.

At Authenticating Input 125, content submissions may be validated for authenticity. The system may identify or authenticate a user or confirm whether a user input derives from the entity's target demographic. For example, photo recognition technology may be used to confirm that a cat is in a photo, or other verification steps may be implemented to ensure a submission meets other requirements.

At Receiving Refined User Input 130, participants may be prompted to answer refined questions based on a participant's answers to a previous question asked at Request User Input 120. For example, at Request Refined User Input 130, a participant may be asked narrower questions such as whether they prefer to use their own scoop or a scoop provided in a cat food package, whether they prefer cat food to be placed on a first, second, or third shelf from a store floor, or whether they prefer that organic cat food also be free of genetically modified organisms (GMOs), for example.

At Aggregating Data 140 and Storing Aggregated Data in a Database 145, information collected from participants' answers, or other data, for example, IP address, geographic location, date, time, demographical information, may be collected and stored in a database. At Analyzing Data 150, data aggregated may be analyzed against issues pertinent to an entity. For example, the data may help determine what type of cat food dispenser is most preferred among cat food purchasers, which location is likely to generate most sales, or what type of ingredients should be added or removed from a current cat food recipe.

At Outputting Recommendation 160, tailored marketing recommendations, for example, may be generated to help the entity monetize or capitalize on the data, for example, by improving sales or profits, increasing social engagement or brand exposure, satisfying existing customers, attracting new customers, enhancing reputation, or achieving other objectives, for example. At Populating GUI with Data/Recommendation 165, the system may populate a graphical user interface (GUI) with data or a recommendation pertinent to the entity.

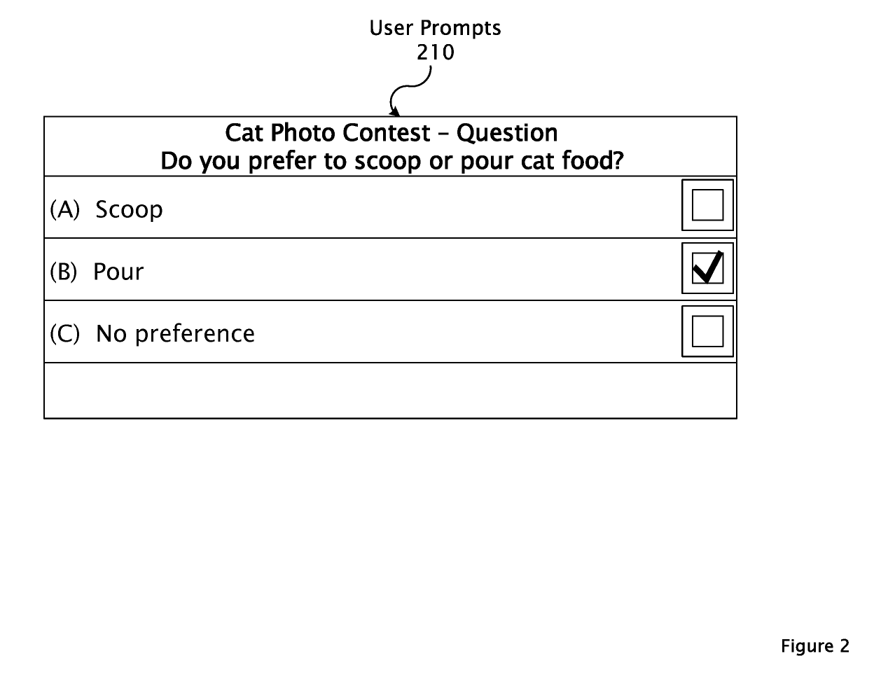

FIG. 2 illustrates a user interface layout for an application or website using a data tracking system, according to one embodiment. In one embodiment, User Prompt 210 may display a question prompting a participant to select one or more answers or allowing the participant to fill in a blank or provide other input such as text, photo, or video. For example, it may ask a user which brands of pet food the user has purchased in the past three months, or it may prompt the user to take another action.

A data tracking process may be built into a software application or an application program interface (API) in an application, or it may be run on an entity's website, for example.

The submitted or shared content may be judged with a specific set of criteria, for example, and may undergo several rounds of feedback, judging, or scoring. As part of the feedback, a participant may be invited to participate in other themed events wherein the participant may wish to submit or share the content. Data tracking may allow an entity to reclaim their audience for social purposes and live outside of social media sites or other host platforms.

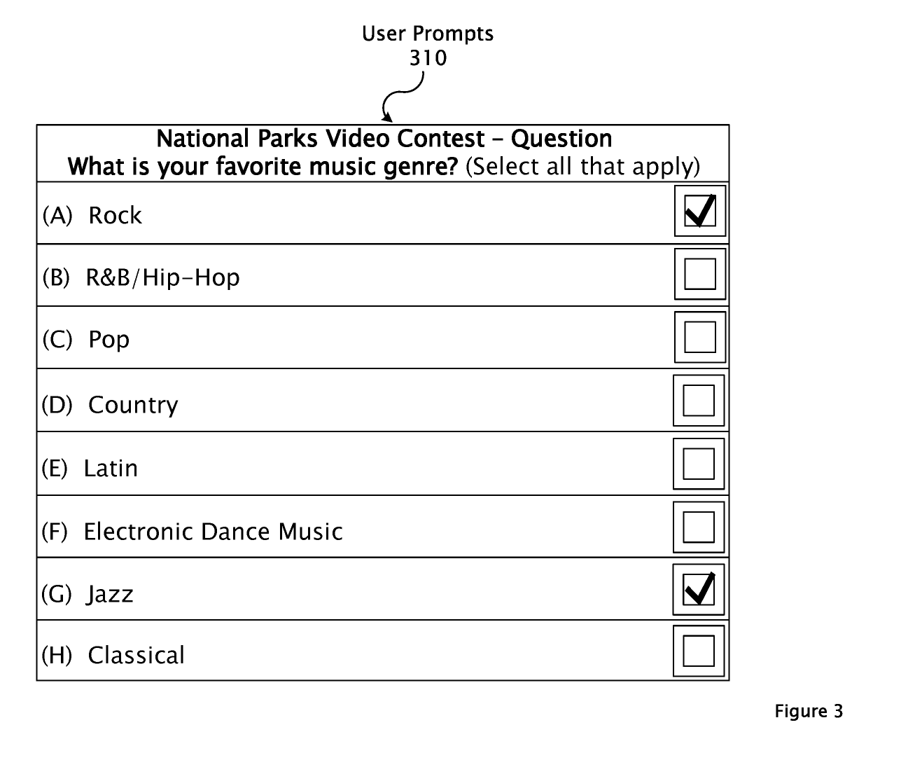

FIG. 3 illustrates a user interface layout for an application or website using a data tracking system, according to one embodiment. User Prompt 310 may display a question prompting a user to select one or more answers or input an answer by text, photo, or video, for example. User Prompt 310, for example, may ask a user which brands of pet food the user has purchased in the past three months, or it may prompt the user to take another action. User Prompt 310 may have various components and configurations, and may be available in any language, format, and context.

In one embodiment, a themed event may not be exclusive to one entity. For example, when a participant submits a photo of a cat, a photo recognition software may identify that both a cat and dog are in the photo. The single photo could be submitted to multiple themed events, for example, to a cat photo contest and a dog photo contest, and multiple entities, for example, a cat food company and a different dog food company, could receive data stemming from the photo.

Questions may only be asked periodically to prevent exhausting participants or turning them away. In one embodiment, an adaptive engine may determine an abandonment rate and allow data tracking to automatically adjust a frequency of Request User Input 120, to keep participants engaged and willing to provide input.

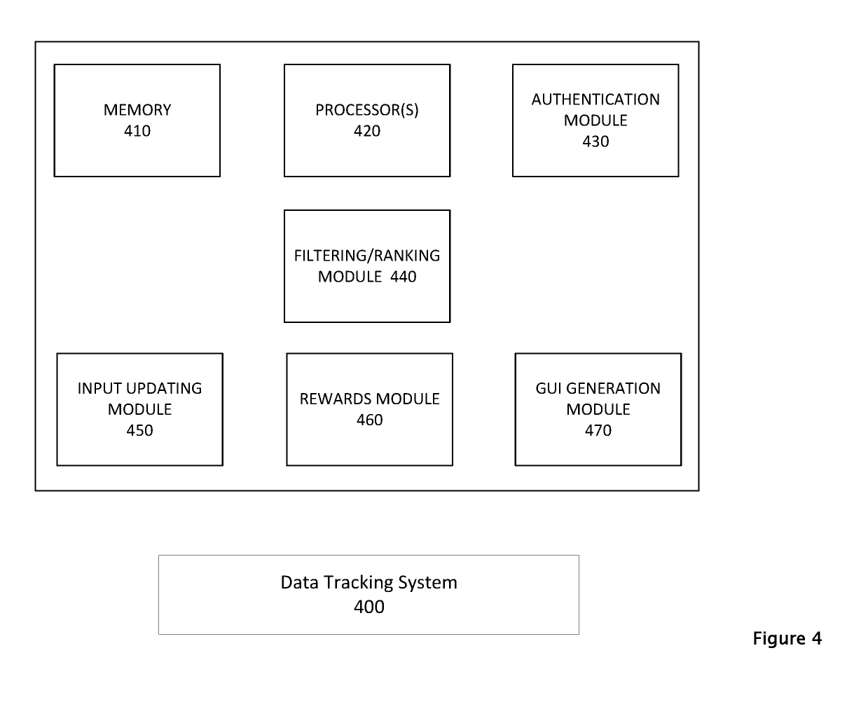

FIG. 4 is a block diagram with components that may be used in a data tracking system, according to one implementation. Data Tracking System 400 may include Memory 410, one or more Processor(s) 420, Authentication Module 430, Filtering/Ranking Module 440, Input Updating Module 450, Rewards Module 460, and Graphical User Interface (GUI) Generation Module 470.

Memory 410 may be any device, mechanism, or populated data structure used for storing information. Memory 410 may be used to store instructions for running one or more applications or modules on Processor(s) 420. For example, Memory 410 may be used in one or more implementations to house all or some of the instructions needed to execute a functionality of Authentication Module 430, Filtering/Ranking Module 440, Input Updating Module 450, Rewards Module 460, and Graphical User Interface (GUI) Generation Module 470.

Authentication Module 430 may be operable to identify or authenticate a user of Data Tracking System 400, for example, to ensure that the user input derives from an entity's target demographic. Filtering/Ranking Module 440 may be operable to filter or rank users engaged in a contest, for example, by providing a score, a rating, or a ranking. Input Updating Module 450 may be operable update Data Tracking System 400 with data supplied by a user, for example, answers or feedback, or from another source. Rewards Module 460 may be operable to process communications or transmissions regarding rewards based on participation of a user. Graphical User Interface (GUI) Generation Module 470 may be operable to generate a GUI screen with information or a recommendation regarding data tracking.

Data Tracking System 400 may include or access a database having stored thereon a plurality of data received from user inputs, or other information. Authentication Module 430 may access the database, or another database, and use the data to filter or rank users. In another implementation, Data Tracking System 400 may also include an application programming interface (API) server, which may be operable to receive information about user inputs or data tracking.

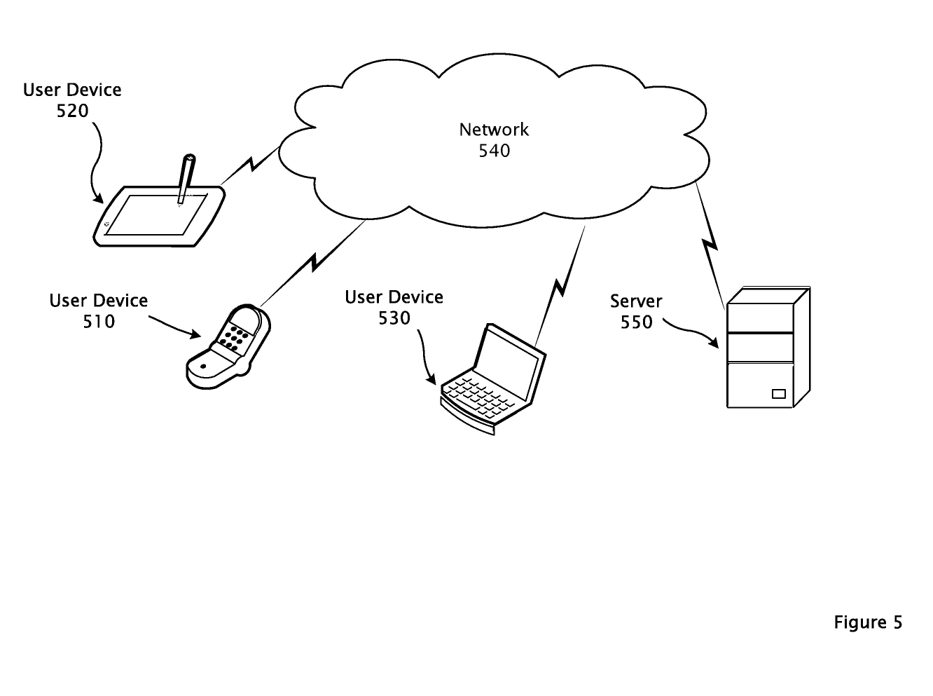

FIG. 5 is a block diagram illustrating an example of a system capable of supporting a data tracking system, according to one embodiment. Network 540 may include Wi-Fi, cellular data access methods, such as 3G or 4GLTE, Bluetooth, Near Field Communications (NFC), the internet, local area networks, wide area networks, or any combination of these or other means of providing data transfer capabilities. In one embodiment, Network 540 may comprise Ethernet connectivity. In another embodiment, Network 540 may comprise fiber optic connections.

User Device 510, 520, or 530 may be a smartphone, tablet, laptop computer, smartwatch or intelligent eyewear, or other device, and may have location-based services, for example, GPS, cell phone tower triangulation capability, or accelerometers, and may have network capabilities to communicate with Server 550. Server 550 may include one or more computers and may serve a number of roles. Server 550 may be conventionally constructed or may be of a special purpose design for processing data obtained from a Data Tracking system. One skilled in the art will recognize that Server 550 may be of many different designs and may have different capabilities.

User Device 510, 520, or 530 may include a device application to support data tracking system, for example, allowing a user to request an action such as enter values for the name of causes they care about, or the name of businesses they need to make a decision about. In another embodiment, Device 510, 520, or 530 may display a website hosted on Server 550 in a browser, which may allow a user to request an action.

In one embodiment, Server 550 may be operated by a party other than a user or an establishment offering data tracking system. Server 550 may be operated by an establishment, allowing a worker to receive a notification of the requested action.

In another embodiment, Server 550 may be operated directly by an establishment offering data tracking system. In this embodiment, a user using User Device 510, 520, or 530 may request an action. User Device 510, 520, or 530 may communicate with Server 550 via Network 540, and Server 550 may notify a worker of the request.

An establishment may also provide a User Device 510, 520, or 530 to a user to provide access to a data tracking system.

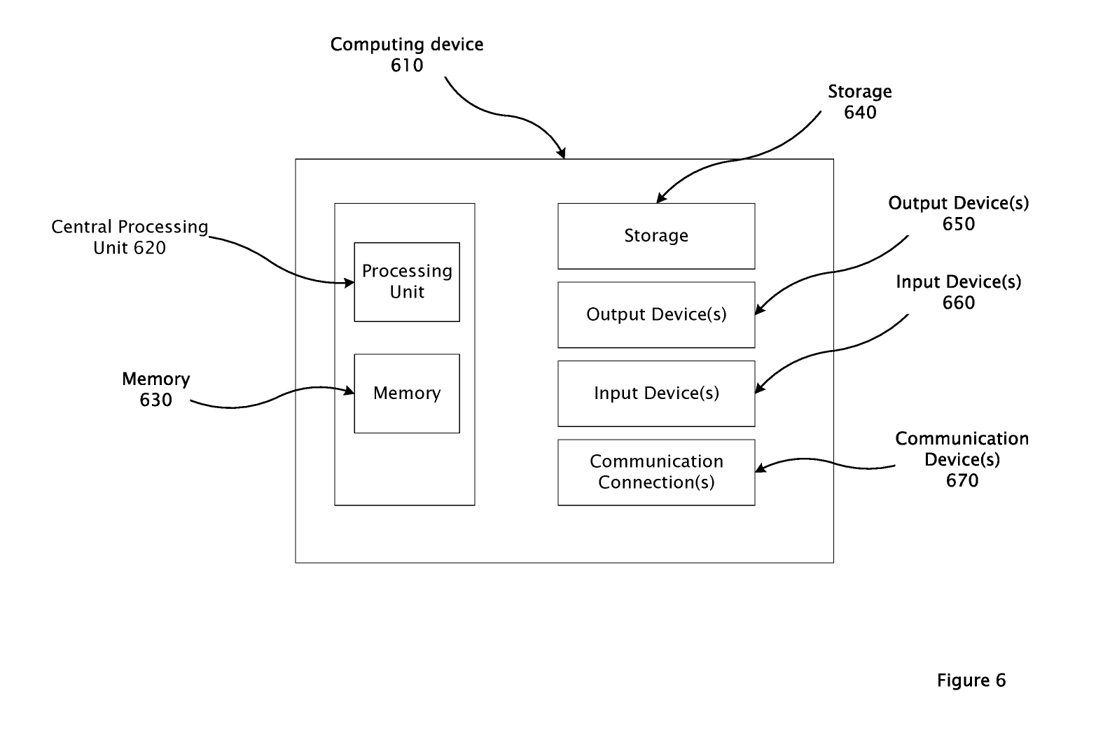

FIG. 6 is a component diagram of Computing Device 610 which may support a data tracking system, according to one embodiment. Computing Device 610 can be utilized to implement one or more computing devices, computer processes, or software modules described herein, including, for example, but not limited to a mobile device. In one example, Computing Device 610 can be used to process calculations, execute instructions, and receive and transmit digital signals. In another example, Computing Device 610 can be utilized to process calculations, execute instructions, receive and transmit digital signals, receive and transmit search queries and hypertext, and compile computer code suitable for a mobile device. Computing Device 610 can be any general or special purpose computer now known or to become known capable of performing the steps or performing the functions described herein, either in software, hardware, firmware, or a combination thereof.

In its most basic configuration, Computing Device 610 typically includes at least one Central Processing Unit (CPU) 620 and Memory 630. Depending on the exact configuration and type of Computing Device 610, Memory 630 may be volatile (such as RAM), non-volatile (such as ROM, flash memory, etc.) or some combination of the two. Additionally, Computing Device 610 may also have additional features/functionality. For example, Computing Device 610 may include multiple CPU's. The described methods may be executed in any manner by any processing unit in computing device 610. For example, the described process may be executed by both multiple CPUs in parallel.

Computing Device 610 may also include additional storage (removable or non-removable) including, but not limited to, magnetic or optical disks or tape. Such additional storage is illustrated by Storage 640. Computer readable storage media includes volatile and nonvolatile, removable and non-removable media implemented in any method or technology for storage of information such as computer-readable instructions, data structures, program modules or other data. Memory 630 and Storage 640 are all examples of computer-readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 610. Any such computer-readable storage media may be part of computing device 610. But computer-readable storage media does not include transient signals.

Computing Device 610 may also contain Communications Device(s) 670 that allow the device to communicate with other devices. Communications Device(s) 670 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer-readable storage media and communication media. The described methods may be encoded in any computer-readable media in any form, such as data, computer-executable instructions, and the like.

Computing Device 610 may also have Input Device(s) 660 such as a keyboard, a mouse, a pen, a voice input device, a touch input device, etc. Output Device(s) 650 such as a display, speakers, printer, etc. may also be included. All these devices are well known in the art and need not be discussed at length.

Those skilled in the art will realize that storage devices utilized to store program instructions may be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above-described logic and still conform to the described embodiments. Further, operations described herein may occur sequentially, or certain operations may be processed in parallel. Yet further operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples, and data provide a complete description of the manufacture and use of the invention. Since many embodiments of the invention can be made without departing from the spirit and scope of the invention, the invention resides in the claims hereinafter appended.

1. A data tracking method, comprising the steps of:
initiating a themed event, the themed event operable to attract social engagement;
receiving a user input;
validating the user input for authenticity;
receiving a refined user input;
aggregating data received from the user input;
storing the aggregated data in a database;
analyzing the data against issues pertinent to an entity;
outputting a recommendation;
populating a graphical user interface with information regarding the data or recommendations.

2. A computer-implemented data tracking system, comprising:
a processor;
a database, the database using having stored data received from user inputs;
an authentication module, the authentication module operable to identify a user or determine whether a user input derives from a target demographic;
a filtering/ranking module operable to filter users or determine a score, rating, or ranking of a user;
an input updating module, the input updating module operable to update the data tracking system with data supplied by a user or another source;
a rewards module operable to determine one or more rewards based on participation of a user; and
a graphical user interface generation module operable to generate a graphical user interface with information or a recommendation regarding data tracking.

3. The computer-implemented system of claim 2, further comprising an adaptive engine, the adaptive engine operable to determine an abandonment rate and allow the data tracking system to automatically adjust a frequency of receiving user input, to keep participants engaged and willing to provide input.

4. The computer-implemented system of claim 2, further comprising an application programming interface (API) server operable to receive information about user inputs or data tracking.
